(19) United States
(12) Patent Application Publication
(10) Pub. No.: US 2014/0087683 A1
(43) Pub. Date: Mar. 27, 2014

(54) METHOD AND APPARATUS OF TEMPORARY LOCAL TRANSMISSION FOR DISASTER INFORMATION DELIVERY

(71) Applicant: Electronics and Telecommunications Research Institute, Daejeon (KR)

(72) Inventors: Hyoung Soo LIM, Daejeon (KR); Yong Tae LEE, Daejeon (KR); So Ra PARK, Daejeon (KR); Yong Hoon LEE, Daejeon (KR); Geon KIM, Daejeon (KR); Myung Sun BAEK, Daejeon (KR); Bo Mi LIM, Chungcheongnam-do (KR); Yun Jeong SONG, Daejeon (KR); Nam Ho HUR, Daejeon (KR)

(73) Assignee: Electronics and Telecommunications Research Institute, Daejeon (KR)

(21) Appl. No.: 14/029,646

(22) Filed: Sep. 17, 2013

(30) Foreign Application Priority Data
Sep. 21, 2012 (KR) 10-2012-0105023
Sep. 13, 2013 (KR) 10-2013-0110055

(51) Int. Cl. H04W 4/22

(52) U.S. Cl. CPC H04W 4/22
USPC 455/404.1; 455/438

(57) ABSTRACT

Disclosed is a method of receiving, by a terminal, an additional network service provided through a temporary base station disposed temporarily or locally in order to transfer disaster information, including: receiving information on the additional network through an existing network service provided by a base station; verifying whether the terminal is handed over to the additional network based on the information on the additional network; and receiving the additional network service through the additional network. According to the present invention, even when a communication service disability occurs due to a flood of telephone traffic in an area where a disaster situation or an event occurs, a communication service can be provided through the additional network in terms of the communication service and a broadcasting channel that provides information specific to the disaster situation or event can be temporarily or locally additionally provided.

This application claims the benefit of priority of Korean Patent Application No. 10-2012-0105023 filed on Sep. 21, 2012 and Korean Patent Application No. 10-2013-0110055 filed on Sep. 13, 2013 all of which are incorporated by reference in its entirety herein.

### BACKGROUND OF THE INVENTION

1. Field of the Invention

The present invention relates to wireless communication, and more particularly, to a method and an apparatus of temporary local transmission for disaster information delivery.

2. Discussion of the Related Art

When rapid and accurate disaster information is delivered to a damage expectation area under a situation that a disaster is expected or already occurs, a scale of damage can be effectively reduced. Various wireless and wired/wireless broadcasting/communication systems can be used as disaster broadcasting media, and as one example, an Ad-Hoc communication service of a scheme which is operated by temporarily configuring a temporary local communication network with respect to an area where a temporary disaster situation or event occurs can be used through efficiently using a wireless mobile communication system. However, when the Ad-Hoc communication network uses a channel which is not used in the existing communication network, a method for notifying control information associated with the presence or not of the channel used by the Ad-Hoc communication network to terminals and handing over the terminals that receive the control information to the corresponding channel is required, but the method is not provided at present. Further, a method regarding how interference with the existing communication network is controlled when the Ad-Hoc communication network commonly uses the channel used in the existing communication network is not presented.

Even in a wireless broadcasting service, a temporary and local service can be provided. In this case, a separate broadcasting signal than the existing broadcasting signal can be transmitted through one or more transmitting towers by using a channel which is not used in the existing broadcasting service in an area to perform disaster broadcasting. However, in this case, since receivers using the broadcasting service cannot sense the presence of a new broadcasting signal according to the existing technology like the Ad-Hoc communication network, the receiver cannot receive the corresponding disaster broadcasting service before arbitrarily searching for the channel or a receiver user sets handover to the corresponding channel in person.

### SUMMARY OF THE INVENTION

An object of the present invention is to provide a method and an apparatus of efficient disaster information delivery.

Another object of the present invention is to provide a method and an apparatus of temporarily or locally transmitting disaster information.

Yet another object of the present invention is to deliver disaster information by using an additional broadcasting or communication channel.

Yet another object of the present invention is to provide a method for a terminal to easily receive disaster information by using deliver disaster information by using an additional broadcasting or communication channel.

In accordance with an embodiment of the present invention, there is provided a method of receiving, by a terminal, an additional network service provided through a temporary base station disposed temporarily or locally. The receiving method may include receiving information on the additional network through an existing network service provided by a base station; Verifying whether the terminal is handed over to the additional network based on the information on the additional network; and receiving the additional network service through the additional network.

In accordance with another embodiment of the present invention, there is provided a method of providing an additional network service provided through a temporary base station disposed temporarily or locally. The providing method may include: transmitting receiving information on an additional network provided by the temporary base station through an existing network service; judging whether the terminal is a target to be handed over to the additional network service; and transmitting information for instructing handover from the existing network service to the additional network service.

In accordance with yet another embodiment of the present invention, there is provided a method of providing an additional network service performed by a temporary base station disposed temporarily or locally. The providing method may include: transferring information on an additional network to an existing base station; providing the additional network service using a different radio channel than an existing network service provided by the existing base station to a terminal; verifying whether an event to terminate the additional network service occurs; and transmitting information for instructing handover from the additional network service to the existing network service to the terminal.

According to the present invention, an additional temporary or local network service can be efficiently provided in a wireless broadcasting network/communication network and an existing terminal (or receiver) can be easily use a disaster broadcasting service. Further, according to the present invention, even when a communication service disability occurs due to a flood of telephone traffic in an area where a disaster situation or an event occurs, a communication service can be provided through the additional network in terms of the communication service and a broadcasting channel that provides information specific to the disaster situation or event can be temporarily or locally additionally provided.

### BRIEF DESCRIPTION OF THE DRAWINGS

FIG. 1 illustrates an example in which an additional network is applied to an area where a disaster situation occurs in accordance with a preferred embodiment of the present invention.

FIG. 2 illustrates an example in which an additional network is applied to an area where a disaster situation occurs in accordance with another preferred embodiment of the present invention.

FIG. 3 illustrates an operational flowchart of a terminal (or receiver) in accordance with a preferred embodiment of the present invention.

FIG. 4 illustrates an operational flowchart of a base station (or transmitter) in accordance with a preferred embodiment of the present invention.

FIG. 5 illustrates an operational flowchart of a temporarily transmitter in accordance with a preferred embodiment of the present invention.

FIG. 6 illustrates an operational flowchart of a temporary base station in accordance with another preferred embodiment of the present invention.

FIG. 7 illustrates a block diagram of a terminal, a base station, and a temporary base station in accordance with the present invention.

### DETAILED DESCRIPTION OF THE EMBODIMENTS

Hereinafter, some embodiments of the present invention will be described in detail with reference to the illustrated drawings. When reference numerals refer to components of each drawing, it is noted that although the same components are illustrated in different drawings, the same components are referred to by the same reference numerals as possible. Furthermore, when it is judged that specific description on known configurations or functions related in describing embodiments of the present invention in the specification may unnecessarily obscure the spirit of the present specification, the detailed description will be omitted.

Further, in the description of the components of the present specification, a terminology such as a first, a second, A, B, (a), (b) may be used. The terminology is used to distinguish a component from the other component but a nature or an order of the component is not limited by the terminology. If it is described that a component is “connected” or “coupled” to the other component, it is understood that the component is directly connected or coupled to the other component but another component may be “connected” or “coupled” between the components.

The present invention includes an existing base station (or transmitter) including an additional network information providing device providing information on a temporary or local broadcasting network or communication network, which is additionally provided, to a terminal (or receiver) through an existing broadcasting or communication service, a temporary base station (or temporary transmitter) providing the temporary or local broadcasting network or communication network which is additionally provided, and user equipment (UE) handing over wireless communication to an additional network (broadcasting network or communication network) in some cases by receiving additional network information from the existing base station (or transmitter). The additional network information may include information on a channel allocated to the additional network, a transmission parameter, a service area or condition, whether the base station receives the additional network service, and the like. Herein, the “network” may indicate a configuration that provide a broadcasting or communication service in link with one or more base stations (or transmitters) or one or more terminals (or receiver). Herein, the base station/terminal will be primarily described and the present invention may be applied to even a broadcast transmitter/receiver as described above.

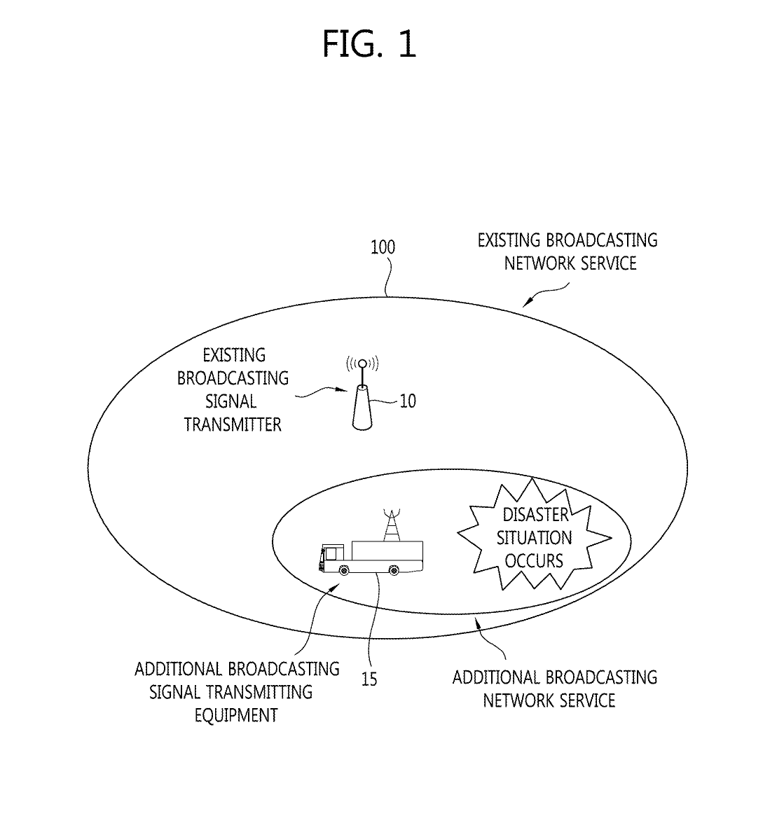

FIG. 1 illustrates an example in which an additional network is applied to an area where a disaster situation occurs in accordance with a preferred embodiment of the present invention.

Referring to FIG. 1, while a broadcast transmitter 10 provides a broadcasting service to receivers positioned in a broadcasting area 100, a temporary transmitter 15 for providing an additional network is disposed in an area where a disaster situation occurs and a broadcasting service specific to the disaster situation in addition to an existing broadcasting service may be additionally provided to receivers in the area where the disaster situation occurs through the additional network. For example, a special-purpose vehicle installed with a broadcasting signal transmitting device for providing the additional network may be used as the temporary transmitter 15. However, for example, the temporary transmitter 15 may become a predetermined broadcasting device installed in an airplane or a ship, or in the existing case in addition to the vehicle.

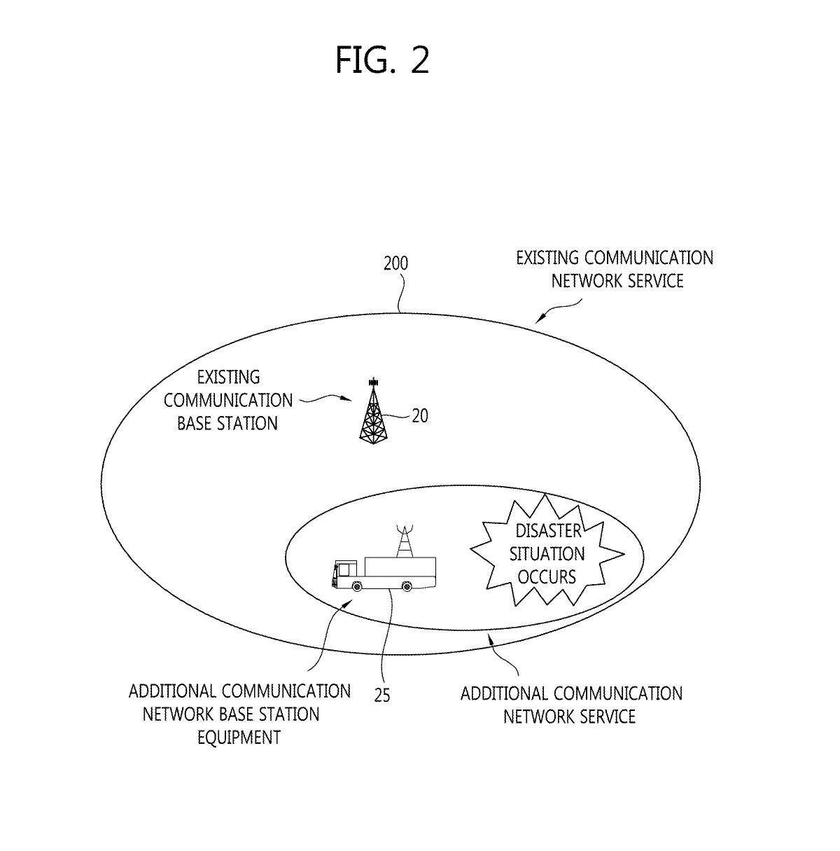

FIG. 2 illustrates an example in which an additional network is applied to an area where a disaster situation occurs in accordance with another preferred embodiment of the present invention.

Referring to FIG. 2, while a communication base station 20 provides a communication service to terminals positioned in a coverage 200, a disaster situation occurs, a temporary base station 25 for providing an additional network is disposed in an area where a disaster situation occurs and a communication service specific to the disaster situation in addition to an existing communication service may be additionally provided to the area where the disaster situation occurs through the additional network. For example, a specula purpose vehicle installed with a communication signal transmitting device for providing the additional network may be used as the temporary base station 25 and besides, may be a predetermined communication device installed in the airplane or the ship, or in the existing case.

The temporary base station 25 additionally provides a communication service through a separate channel to terminals, and as a result, the existing communication network may be prevented from being destroyed due to a flood of calls, texts, and SNSs which are temporarily and suddenly increased due to the occurrence of the disaster situation. In this case, the temporary base station 25 autonomously provides a single cell communication network function to provide a communication service between terminals that belong to the corresponding area. Further, the temporary base station 25 may provide connected with an existing communication network (a terrestrial communication network or a satellite communication network) and in this case, may provide a communication service between a terminal which is positioned in an area where the corresponding disaster situation occurs and a predetermined other terminal. In addition, the temporary base station 25 may include integration base station control equipment for interworking with the existing communication network or the satellite communication network. The temporary base station 25 may provide an additional communication network service to a plurality of communication operator service subscribers.

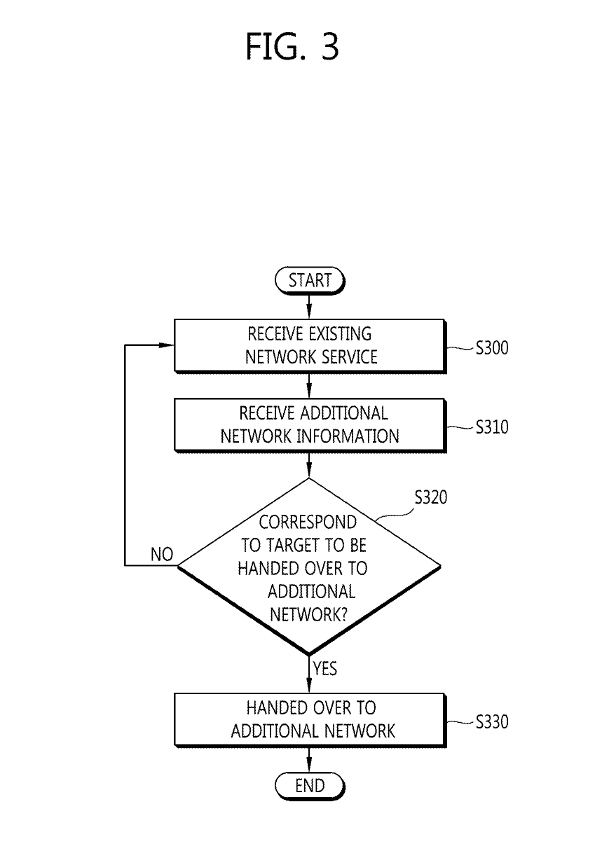

FIG. 3 is an operational flowchart of a terminal (or receiver) according to a preferred embodiment of the present invention. Hereinafter, the terminal will be primarily described and the terminal according to the present invention may include a broadcast receiver.

Referring to FIG. 3, the terminal receives an existing network service (S300). That is, the terminal may receive a communication service through an existing network provided by a base station.

The terminal receives information on an additional network (S310). In this case, a disaster situation may occur or the terminal may be positioned in an area where the corresponding disaster situation occurs or in the vicinity thereof. The additional network may be provided through a temporary base station. The terminal may receive the additional network information through the existing network. The additional network information may include information on a channel allocated to the additional network, a transmission parameter, a service area or condition, whether the terminal receives the additional network service, and the like.

The terminal judges whether the terminal itself corresponds to a target to be handed over to the additional network based on the received additional network information (S320). In this case, the terminal may judge whether the terminal itself corresponds to the target to be handed over to the additional network by further considering the location of the terminal, a priority of handover to the additional network, a user set-up, and the like. Meanwhile, in some cases, the terminal that receives the additional network information may immediately judge that the terminal itself corresponds to the target to be handed over to the additional network. In this case, S320 may be omitted.

In S320, when the terminal corresponds to the target to be handed over to the additional network, the terminal is handed over to the additional network (S330). That is, the terminal may be handed over to the additional network through a handover to the temporary base station (a cell of the temporary base station) providing the additional network or a channel handover in the base station (a cell of the base station) providing the existing network.

Meanwhile, in S320, when the terminal does not correspond to the target to be handed over to the additional network, step S300 is again performed.

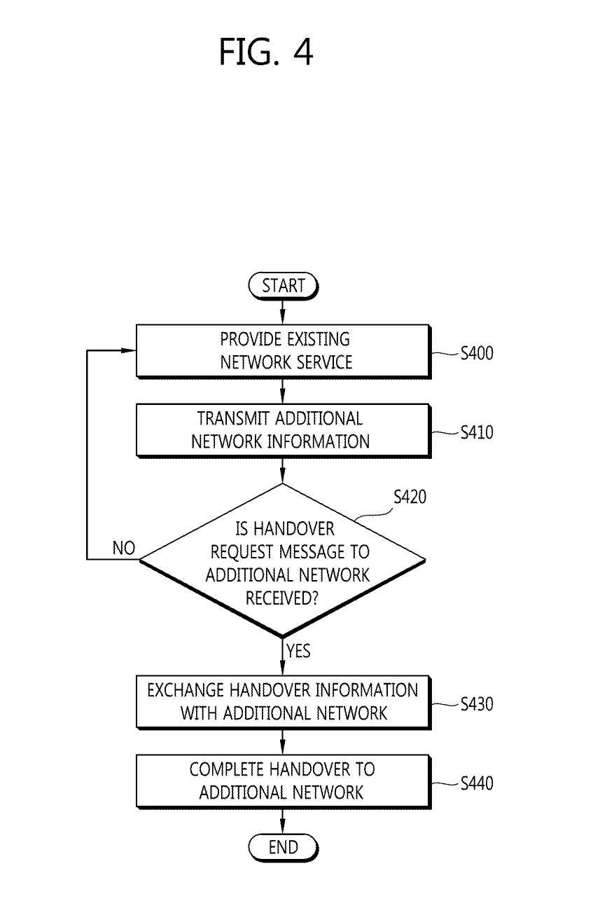

FIG. 4 is an operational flowchart of a base station (or transmitter) in accordance with a preferred embodiment of the present invention. Hereinafter, the base station will be primarily described and the base station according to the present invention may include a broadcast transmitter.

The base station provides the existing network service to the terminal (S400). That is, the base station may provide the communication (or broadcasting) service to the terminal through the existing network.

The base station provides information on an additional network to the terminal (S410). The additional network may represent a network provided by the temporary base station. The base station may provide the additional network information to the terminal through the existing network. For example, in the case of a wireless broadcasting system, the base station (or transmitter) may insert a control signal including the additional network information into a stream of the existing network service and periodically transmit the stream inserted with the control signal while providing the existing network service. The additional network information may include information on a channel allocated to the additional network, a transmission parameter, a service area or condition, whether the base station receives the additional network service, and the like.

The base station verifies whether to receive a handover request message to the additional network (S420). In S420, when the base station receives the handover request message to the additional network from the terminal, the base station exchanges handover information with the temporary base station providing the additional network (S430). Examples of the handover information may include a terminal ID, a connection ID, information on a service being used, synchronization information, and the like.

Thereafter, the base station hands over the terminal to the additional network of the temporary base station (S440). In this case, the base station may transmit a handover command to the terminal. In this case, the base station may be called a source base station and the temporary base station may be a target base station.

Meanwhile, in S420, when the base station cannot receive the handover request message to the additional network from the terminal, the base station performs step S400.

Although the handover process is performed by considering whether the base station receives the handover request message to the additional network from the terminal, in S420 of FIG. 4, when the base station directly judges whether the corresponding terminal is handed over to the additional network, the base station may perform the handover process for the terminal without additionally receiving the handover request message to the additional network from the terminal. In this case, step S420 may be omitted.

Meanwhile, in case of broadcasting network, step S420, S430, and S440 may be omitted.

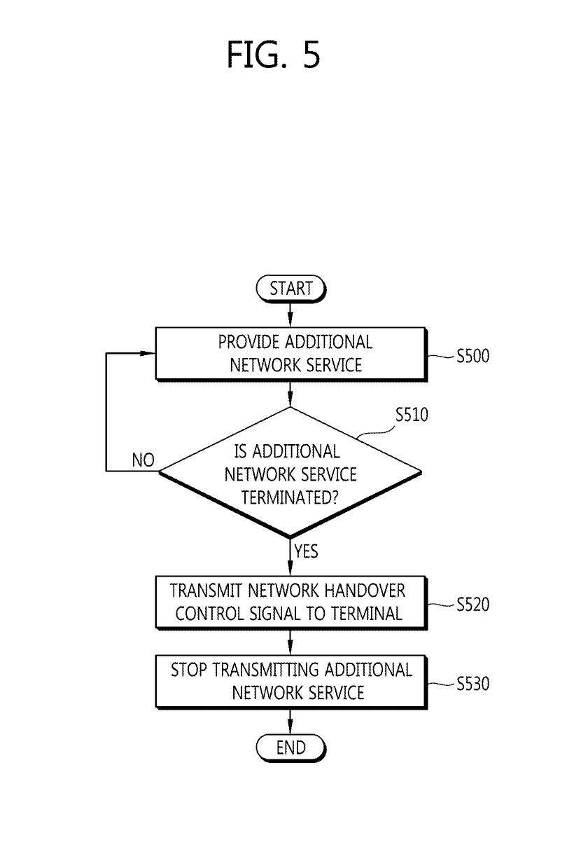

FIG. 5 illustrates an operational flowchart of a temporarily transmitter in accordance with a preferred embodiment of the present invention. In FIG. 5, the temporary transmitter of the wireless broadcasting system is primarily described, but the operational flowchart may be applied to even the temporary base station of the wireless communication system within a scope in which a technical configuration is the same or similar.

Referring to FIG. 5, the temporary transmitter provides the additional network service to the terminal (or receiver) (S500). That is, the temporary transmitter provides the wireless broadcasting (or communication) service to the terminal through the additional network.

The temporary transmitter verifies whether the additional network service is terminated (S510). For example, when the additional network service needs to be terminated like a case in which the disaster situation or event is terminated, the temporary transmitter may terminate the additional network service.

In S510, when the additional network service is terminated, the temporary transmitter transmits a network handover control signal to the terminal (or receiver) (S520). The network handover control signal is a control signal for handing over the terminal (or receiver) that receives the additional network service to the existing network again.

Thereafter, the temporary transmitter stops transmitting the additional network service (S530). The temporary transmitter induces the terminal (or receiver) to be handed over to the existing network in step S520 and thereafter, stops transmitting the additional network service to prevent the service from being cut.

Meanwhile, in S510, when the additional network service is not terminated, the temporary transmitter performs step S500 of providing the additional network service to the terminal (or receiver).

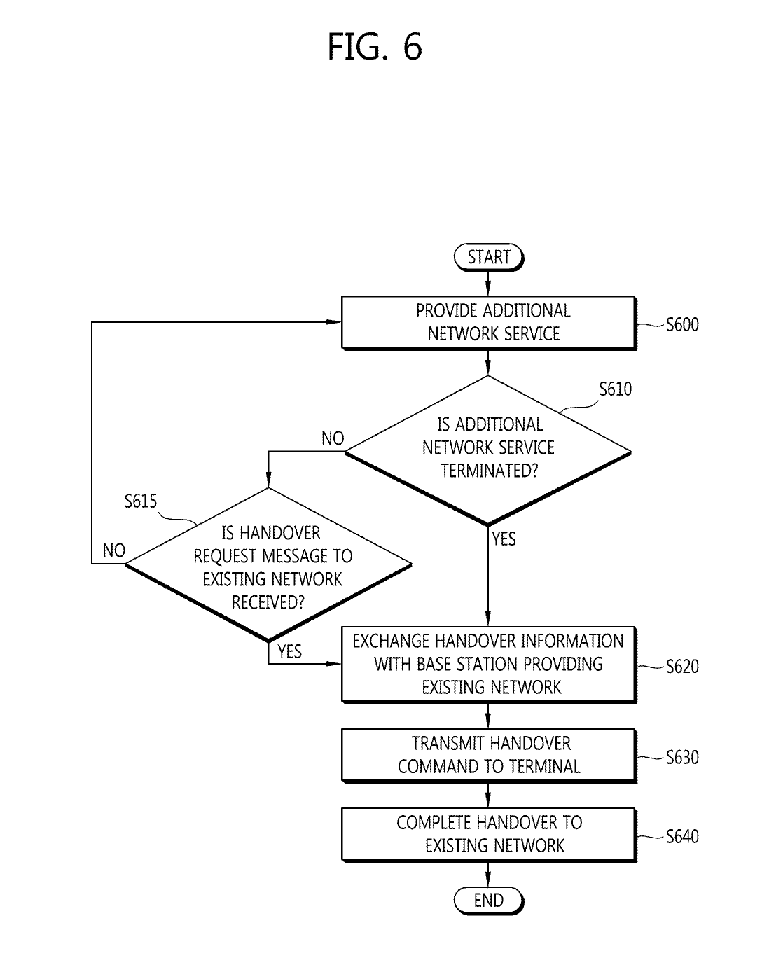

FIG. 6 illustrates an operational flowchart of a temporary base station in accordance with another preferred embodiment of the present invention. In FIG. 6, the temporary transmitter of the wireless communication system is primarily described, but the operational flowchart may be applied to even the temporary base station of the wireless broadcasting system within a scope in which a technical configuration is the same or similar. Hereinafter, the base station according to the present invention may include the transmitter.

Referring to FIG. 6, the temporary base station provides the additional network service to the terminal (or receiver) (S600). That is, the temporary base station provides the wireless communication (or broadcasting) service to the terminal through the additional network.

The temporary base station verifies whether the additional network service is terminated (S610). For example, when the additional network service needs to be terminated like a case in which the disaster situation or event is terminated, the temporary base station may terminate the additional network service.

When the additional network service is terminated in S610, the temporary base station exchanges handover information with a neighboring base station providing the existing network (S620) and transmits a handover command to the terminal (S630). Subsequently, the temporary base station performs remaining steps for completing the handover (S640).

Meanwhile, in S610, when the additional network service is not terminated, the temporary base station verifies whether to receive a handover request message to the existing network (S615).

In S615, when the temporary base station receives the handover request message to the existing network from the terminal, the temporary base station exchanges handover information with a neighboring base station providing the existing network (S620) and transmits a handover command to the terminal (S630). Subsequently, the temporary base station performs remaining steps for completing the handover (S640).

Meanwhile, in S610, when the temporary base station does not receive the handover request message to the existing network from the terminal, the temporary base station performs step S600 of providing the additional network service to the terminal (or receiver).

The temporary or local additional network service may be efficiently provided in the wireless broadcasting network/communication network through such a method. An existing terminal (or receiver) may easily use a disaster broadcasting service. According to the present invention, the communication service may be provided through the additional network even when a communication service disability occurs due to a flood of telephone traffic in an area where a disaster situation or an event occurs in terms of the communication service. Further, in terms of the broadcasting service, a broadcasting channel providing information specific to the disaster situation or event may be temporarily or locally additionally provided.

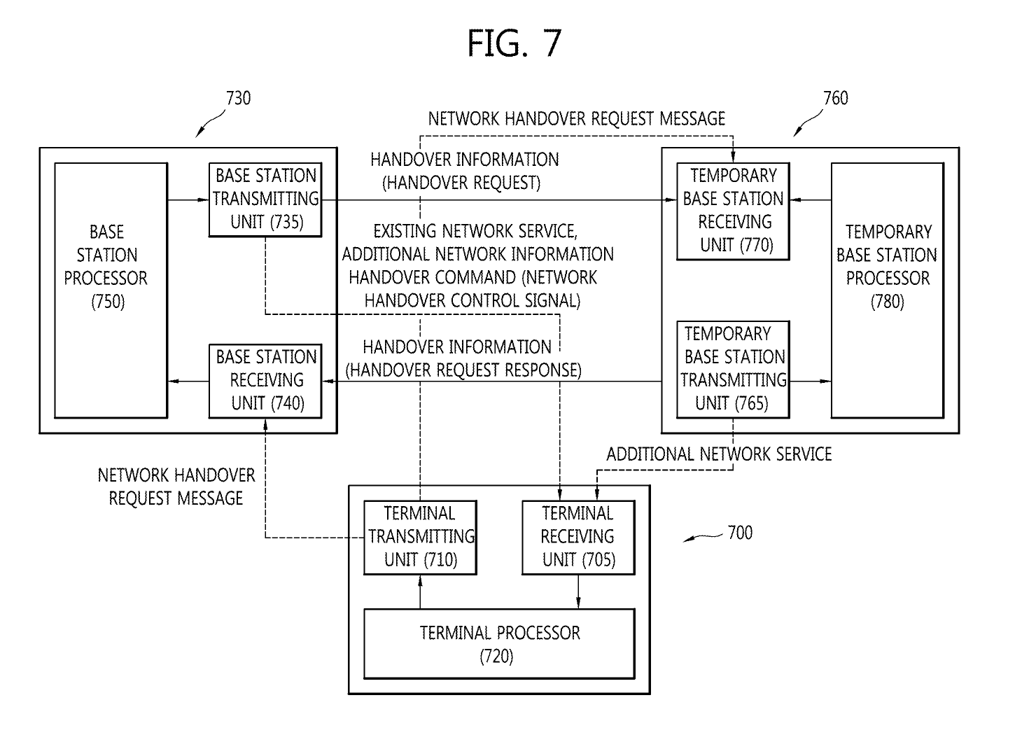

FIG. 7 illustrates a block diagram of a terminal, a base station, and a temporary base station according to the present invention.

Referring to FIG. 7, the terminal 700 according to the present invention receives an existing net service through the base station 730, and the temporary base station 760 may temporarily or locally provide an additional network service to the terminal 700 if necessary.

The terminal performs function and control required to implement the aforementioned features of the present invention. The terminal 700 may include the aforementioned receiver.

The terminal includes a terminal receiving unit 705, a terminal transmitting unit 710, and a terminal processor 720.

The terminal receiving unit 705 receives an existing network service from the base station 730. The terminal receiving unit 705 receives the service through the existing network and receives additional network information through the existing network. The additional network information may include information on a channel allocated to the additional network, a transmission parameter, a service area or condition, whether the terminal receives an additional network service, and the like.

The terminal processor 720 determines whether or not to correspond to a handover target to the additional network based on the additional network information. The terminal processor 720 may determine whether or not to correspond to a handover target to the additional network by further considering a location of the terminal 700, a priority of additional network handover, a user set-up, and the like.

The terminal processor 720 performs a process for handover to the additional network, when the terminal 700 corresponds to the handover target to the additional network. For example, the terminal processor 720 may perform a handover process or a channel handover process. In this case, the terminal receiving unit 705 may receive a handover command or a network handover control signal from the base station 730.

The terminal transmitting unit 710 may transmit a handover request message to the additional network to the base station 730. Alternately, The terminal transmitting unit 710 may transmit a handover request message to the existing network to the temporary base station 760.

The base station 730 performs function and control required to implement the aforementioned features of the present invention. The base station 730 may include the aforementioned transmitter.

The base station 730 includes a base station transmitting unit 735, a base station receiving unit 740, and a base station processor 750.

The base station transmitting unit 735 provides (or transmits) the existing network service to the terminal 700. The base station transmitting unit 735 provides the additional network information to the terminal 700. For example, in the case where the basic network provided by the base station transmitting unit 735 is a broadcast network, the base station transmitting unit 735 may insert a control signal including the additional network information into a service stream of the existing network to periodically transmit the service stream inserted with the control signal.

The base station receiving unit 740 may receive a handover request message to the additional network from the terminal 700.

The base station processor 750 exchanges handover information with the temporary base station 760 providing the additional network, when the base station receiving unit 740 receives the handover request message to the additional network. For example, the base station processor 750 may transmit a handover request message to the temporary base station 760 through the base station transmitting unit 735, and receive a handover request response message from the temporary base station 760 through the base station receiving unit 740. Thereafter, the base station processor 750 may transmit the handover command to the terminal 700 through the base station transmitting unit 735.

Alternately, the base station processor 750 may directly determine whether or not to hand over the terminal 700 to the additional network and control performing the handover process, regardless of whether the base station receiving unit 740 receives the handover request message to the additional network.

The temporary base station 760 performs function and control required to implement the aforementioned features of the present invention. The temporary base station 760 may include the aforementioned temporary transmitter.

The temporary base station 760 includes a temporary base station transmitting unit 765, a temporary base station receiving unit 770, and a temporary base station processor 780.

The temporary base station 760 is temporarily or locally disposed to provide an additional network service to the terminal 700 in the case where a disaster situation, an event, or the like occurs.

The temporary base station transmitting unit 765 provides the additional network service to the terminal 700. The temporary base station transmitting unit 765 may transfer the additional network information to the base station 730.

The temporary base station receiving unit 770 may receive a handover request message to the existing network from the terminal 700.

The temporary base station processor 780 transmits a network conversion control signal to the terminal 700 when the additional network service is terminated, or the temporary base station receiving unit 770 receives the handover request message to the existing network. The network handover control signal is a control signal for handing over the terminal 700 receiving the additional network service into the existing network again. Thereafter, the temporary base station processor 780 stops transmitting the additional network service provided to the terminal 700 through the temporary base station transmitting unit 765.

Alternately, the temporary base station processor 780 exchanges handover information with the base station 730 providing the existing network, when the additional network service is terminated, or the temporary base station receiving unit 770 receives the handover request message to the existing network. For example, the temporary base station processor 780 may transmit a handover request message to the base station 730 through the temporary base station transmitting unit 765, and receive a handover request response message from the base station 730 through the temporary base station receiving unit 770. Thereafter, the temporary base station processor 780 may transmit the handover command to the terminal 700 through the temporary base station transmitting unit 765.

It will be appreciated that various embodiments of the present invention have been described herein for purposes of illustration, and that various modifications, changes, substitutions may be made by those skilled in the art without departing from the scope and spirit of the present invention. Accordingly, the various embodiments disclosed herein are not intended to limit the technical spirit but describe with the true scope and spirit being indicated by the following claims. The scope of the present invention may be interpreted by the appended claims and the technical spirit in the equivalent range are intended to be embraced by the invention.

What is claimed is:

1. A method of receiving, by a terminal, an additional network service provided through a temporary base station disposed temporarily or locally, the method comprising:
receiving information on the additional network through an existing network service provided by a base station;
verifying whether the terminal is handed over to the additional network based on the information on the additional network; and
receiving the additional network service through the additional network.

2. The method of claim 1, wherein:
the temporary base station is disposed to transfer disaster information and the temporary base station transfer a disaster situation into a predetermined area through the additional network.

3. The method of claim 1, wherein:
the additional network uses a different radio channel than the existing network, and
the information on the additional network may include at least one of information on a channel allocated to the additional network, a transmission parameter, a service area or condition, and whether the terminal receives the additional network service.

4. The method of claim 3, wherein:
whether the terminal is handed over to the additional network is verified based on further at least one of a location of the terminal, a priority of additional network handover, and a user set-up.

5. The method of claim 3, wherein:
in the receiving of the information on the additional network, when the basic network is a broadcasting network, a control signal including the information on the additional network is periodically received through a service stream of the existing network.

6. The method of claim 5, further comprising:
receiving a network handover control signal from the base station; and
performing network handover from the existing network of the base station to the additional network of the temporary base station.

7. The method of claim 3, further comprising:
transmitting a handover request message to the additional network to the base station.

8. The method of claim 3, further comprising:
receiving a handover command from the base station; and
performing a handover process from the base station to the temporary base station.

9. A method of providing an additional network service provided through a temporary base station disposed temporarily or locally, the method comprising:
transmitting receiving information on an additional network provided by the temporary base station through an existing network service;
judging whether the terminal is a target to be handed over to the additional network service; and
transmitting information for instructing handover from the existing network service to the additional network service.

10. The method of claim 9, wherein:
the temporary base station is disposed to transfer disaster information and the temporary base station transfer a disaster situation into a predetermined area through the additional network.

11. The transformer of claim 9, wherein:
the additional network uses a different radio channel than the existing network, and
the information on the additional network may include at least one of information on a channel allocated to the additional network, a transmission parameter, a service area or condition, and whether the terminal receives the additional network service.

12. The method of claim 11, further comprising:
receiving a handover request message to the additional network from the terminal.

13. The method of claim 11, further comprising:
transmitting the handover request message to the temporary base station; and
receiving a handover request response message from the temporary base station,
wherein the information for instructing the handover from the existing network service to the additional network service is a handover command.

14. The method of claim 11, wherein:
in the transmitting of the information on the additional network, when the existing network is a broadcasting network, a control signal including the information on the additional network is periodically transmitted through a service stream of the existing network.

15. The method of claim 11, wherein:
the additional network is a broadcasting network or a communication network.

16. A method of providing an additional network service performed by a temporary base station disposed temporarily or locally, the method comprising:
transferring information on an additional network to an existing base station;
providing the additional network service using a different radio channel than an existing network service provided by the existing base station to a terminal;
verifying whether an event to terminate the additional network service occurs; and
transmitting information for instructing handover from the additional network service to the existing network service to the terminal.

17. The method of claim 16, wherein:
the temporary base station is disposed to transfer disaster information and the temporary base station transfer a disaster situation into a predetermined area through the additional network.

18. The method of claim 16, wherein:
the information on the additional network may include at least one of information on a channel allocated to the additional network, a transmission parameter, a service area or condition, and whether the terminal receives the additional network service.

19. The method of claim 16, further comprising:
transmitting a handover request message to the existing base station; and
receiving a handover request response message from the existing base station,
wherein the information for instructing the handover from the additional network service to the existing network service is a handover command message.

20. The method of claim 16, wherein:
the additional network adopts a broadcasting network or a communication network.
